(19) United States
(12) Patent Application Publication
(10) Pub. No.: US 2024/0399399 A1
(43) Pub. Date: Dec. 5, 2024

(54) A POWDER COATING SYSTEM

(71) Applicant: TUSAS- TURK HAVACILIK VE UZAY SANAYII ANONIM SIRKETI, Kahramankazan/Ankara (TR)

(72) Inventor: Sertac ALTINOK, Kahramankazan/Ankara (TR)

(21) Appl. No.: 18/695,212

(22) PCT Filed: Sep. 28, 2022
(86) PCT No.: PCT/TR2022/051051

§ 371 Date: Mar. 25, 2024

(30) Foreign Application Priority Data
Sep. 30, 2021 (TR) 2021/015329

(51) Int. Cl. B05B 7/22; B05B 7/14; B05B 12/08; B05B 13/02

(52) U.S. Cl. CPC B05B 7/226; B05B 7/1477; B05B 12/082; B05B 12/084; B05B 13/0221

(57) ABSTRACT

A power coating system for a material in liquid, solid and/or gaseous form used in engineering applications. At least one feeding unit enables the material to be transmitted at a feed rate predetermined by the user. At least one plasma torch located in connection with the feeding unit enables the form of the material to be converted by the atomization method. A powder in an amount predetermined by the user is formed by conversion of the material by the plasma torch. A plurality of reservoirs allow the powder to be separated and collected in sizes predetermined by the user. At least one transmission line allows the powders to be conveyed to the reservoir. A vacuum unit allows the powders to be conveyed by vacuum on the transmission line where at least one part is pre-positioned by the user into the reservoir for applying the coating process.

The present invention relates to a coating process for powder production and powder separation systems.

Coating technologies are mainly carried out to improve surface characteristics of a part in terms of a certain performance characteristic. Applications in coating technologies are generally hot/cold coating material immersion, hot/cold spraying, physical gas deposition (PVD), chemical gas deposition (CVD) and electronic deposition. Regardless of whether the spraying method is cold or hot, it is mostly carried out with pre-synthesized materials in powder form with a certain composition and size. These powder materials are delivered to a spray gun by means of a high-pressure gas and ejected through an outlet area, which is aimed at the surface to be coated. The morphology and size of the powder during the process are directly related to the quality of the coating.

Many of the methods for obtaining a powder result in a powder with irregular morphology. Materials powdered by mechanical processes are generally obtained by breaking down the weak points of the particles with the effect of an impact force, so that they are broken into powder particles with irregular morphology. The resulting powder materials are obtained in an irregular form. In chemical processes, a supersaturated solution is created either by the use of heat or by different methods, after which the solute begins to precipitate to have the powder form, when the required conditions are met. However, spherical particles can occur in high-purity solutions, which leads to a difficulty in adjusting sizes and achieving industrial production. It is not a suitable method for obtaining metal powder.

The spherical powder form is obtained by the plasma atomization method. Plasma methods mainly consist of a system for creating a plasma; a reactor for providing solidification in air; a collector for accumulating the powders; gas flow systems for keeping the system at a constant pressure; vacuum systems and outlet systems.

U.S. Pat. No. 11,059,099B1, which is included in the known-state of the art, discloses a method for producing powder particles by atomization of a feed material in the form of an elongated member such as a wire, a rod or a filled tube. Also disclosed are introducing the feed material in a plasma torch, moving the feed material from the plasma torch into an atomization nozzle of the plasma torch, and surface melting a forward end of the feed material by exposure to one or more plasma jets formed in the atomization nozzle.

A powder coating system according to the present invention enables process steps of powder synthesis, separation and coating to be performed simultaneously.

Another object of the present invention is to provide an automatic powder coating system for process steps of powder synthesis, separation and coating, which can be controlled by a control unit.

Another object of the present invention is to save time by means of the powder coating system.

A further object of the present invention is to provide a simple, easy to use, practical, and effective powder coating system.

The powder coating system realized to achieve the object of the present invention, which is defined in the first claim and other claims dependent thereon, comprises conversion of more than one type of solid, liquid or gaseous materials used in engineering applications into powder form by a plasma atomization, arc plasma or plasma induction method. Solid, liquid or gaseous pure elements, alloys, liquid or gaseous chemical substances required to produce a material in a composition predetermined by the user are transferred to a feeding unit in a required amount. These connected feeding units will accurately and regularly measure the flow rates of the material type to be fed, and the feeding units will be combined just before a plasma region to enter the plasma region simultaneously. The gaseous material consists of being injected into the plasma torch before or during plasma atomization. Liquid starting materials are supplied by a peristaltic pump. Gases are transferred to the plasma region by flow meters. The powder coating system comprises a plurality of reservoirs which allow the material converted into a powder form to be separated and collected in sizes predetermined by the user. The powder coating system comprises a transmission line for conveying the powders to the reservoirs. The powder coating system comprises a vacuum unit for vacuum transport of powders on the transmission line. It comprises coating at least one part in the reservoir, which is coated in dimensions predetermined by the user.

The powder coating system according to the invention comprises a vacuum unit which vacuums each reservoir simultaneously, allowing the process of coating the part in the reservoir to continue, while the processes of synthesizing the material to the powder size predetermined by the user and separating the material into the powder sizes predetermined by the user continue.

In an embodiment of the invention, the powder coating system comprises a torch which generates plasma for the methods of plasma atomization, arc plasma, inductively coupled plasma, or microwave; a first reservoir attached to a reactor in which solidification takes place, wherein the first reservoir is located at a bottom part of said reactor. The powder coating system comprises the first reservoir extending from the plasma torch, which allows the storage of the material converted to powder form. Feed materials are passed through the plasma formed as a result of ionization of gases sent to the plasma torch, so that the feed materials are melted into droplets, and the melted droplets are moved into the reactor section to solidify in the air. In order for the system to operate, a continuous flow of gas is provided, and liquid droplets near the entrance of the reactor and particles that solidify while moving down the reactor move through the system in the form of an aerosol flow in this gas. The aerosol moving through the reactor is collected in different sizes by a series of specially designed reservoirs in order to obtain the particles in the flow. Particles in aerosol flow form with the effect of vacuum are transmitted to a second reservoir in the vacuum direction. Coarse powders, whose vacuum-induced force is higher in weight due to the size of the particles, are stored in the first reservoir. The powder coating system comprises the second reservoir, wherein micro and nano-sized powders having smaller particle sizes than the powders in the first reservoir are transferred to the second reservoir, with the effect of pressure difference, by the vacuum unit which creates vacuum by gravity. The powder coating system comprises a third reservoir, wherein nano-sized powders reaching the second reservoir through the transmission line, which show high force against the vacuum effect, are transmitted to the third reservoir by the transmission line with the effect of pressure difference of the vacuum system that creates vacuum by gravity. The powder coating system comprises a single vacuum unit which enables the transmission lines between each reservoir to be of different geometry, width, diameter and/or enables the transmission lines to be pressurized differently from each other with the effect of vacuum. It is an induction melting torch and atomizing system, wherein in the last section where the transmission line carrying the powders in the system communicates into the coating reservoir with nano-sized powders, the system allows the powders to be accelerated by applying heat while they are in motion and keeping them in molten form, semi-melt form or solid phase. This system comprises reaching the coating surface in a desired form and speed with the relevant parameters, depending on the desired coating feature, when the powders reach the coating reservoir. It includes the production of each reservoir from a heat-resistant material.

In an embodiment of the invention, the powder coating system comprises two sections located in the first reservoir. The powder coating system comprises a first coating chamber, which provides coating to the part in the first reservoir; and a first separation chamber, which enables separation of the material converted into powder form into the reservoirs. The powder coating system comprises the first separation chamber for the simultaneous and permanent continuation of the powder separation processes when the user wishes to continue and/or stop the coating process in the first coating chamber. The powder coating system comprises a second separation chamber which is located in the second reservoir receiving the powders separated from the first reservoir according to the powder size, and which provides the transfer of the powders to the third reservoir in an amount predetermined by the user. The powder coating system comprises a second coating chamber which enables coating on the part simultaneously with the powders in the second reservoir in the amount determined by the user. The powder coating system comprises a third separation chamber which provides the transfer of the powders in the third reservoir, wherein the powders with a smaller particle size than the powders in the second reservoir are transferred to the third reservoir; a third coating chamber which allows coating on the part simultaneously with the separation process carried out in the third separation chamber. The powder coating system comprises a valve located at an upper part of each reservoir. The powder coating system comprises a second position in which the valve is closed to stop the coating process of the part in any reservoir that reaches the coating thickness predetermined by the user, while the powder separation and part coating processes continue simultaneously in a first position in which the valves are open.

In an embodiment of the invention, the powder coating system comprises a table in the reservoir, which allows powder in different particle sizes predetermined by the user to be created on the same part, wherein the table allows the part to be moved in the reservoir at least in x, y, z directions; a motor triggering the movement of the table.

In an embodiment of the invention, the powder coating system comprises the part which is coated in the first reservoir, such that the part is coated simultaneously with the synthesis of the material to the powder size desired by the user, by any of the following methods: immersion, electronic deposition, hot spraying with liquid droplets in spherical form in which the table approaches the plasma torch temperature or cold spraying by means of a powder which is in solid form when sprayed, Physical Vapor Deposition in case of deposition without a reaction between the droplets obtained in gas form and the coated surface by increasing the energy of the plasma torch, Chemical Vapor Deposition on the gas droplets that react chemically upon chemical reaction of the gas synthesized with the coated surface; the part coated in the second reservoir and the third reservoir with the cold spray method such that the part is coated simultaneously with the synthesis of the material to the powder size. The target material, which is synthesized in the form of liquid or gas in the plasma region, enters the reactor section with the vertical movement of plasma gases with the effect of gravity. The powder coating system comprises a movable table for converting the synthesized material, which is in a liquid form in the region near the plasma outlet, from the liquid form to the semi-liquid form, that is, the solid and liquid form together, as the synthesized material moves through the reactor, such that the synthesized material is converted into spherical solid particles as it further moves vertically through the reactor.

In an embodiment of the invention, the powder coating system comprises a composition meter which measures organic material composition of powders by characterizing (in situ) the gases obtained by inert gas fission (IGF) based combustion method. The powder coating system comprises a control unit which changes and controls the feeding speed in the feeding unit according to the measurement data obtained. The powder coating system comprises the composition meter transmitting the feed rate, material feed rate and composition of the feeding unit to the control unit for the control unit to change them.

In an embodiment of the invention, the powder coating system comprises the control unit which controls simultaneously with the composition meter the material characteristic previously input into the control unit by the user, using the ideal data reference machine learning method. The powder coating system comprises the control unit which allows changing the material input data, changing the feeding rate of the materials that can be in different phases and different elements in the feeding unit, and converging them substantially to the material composition ratio pre-input by the user in the control unit, wherein the control unit controls said process.

In an embodiment of the invention, the powder coating system comprises a particle size meter which measures the particle size data of the powder by using the laser diffraction method. The powder coating system comprises the control unit to which the particle size meter transmits the measured data in order for the control unit to control the data and accordingly to control the feed rate.

In an embodiment of the invention, the powder coating system comprises a sensor located in each reservoir and transferring the data pre-input by the user to the system regarding the coating thickness to the control unit while coating the part. The control unit controls material transmission amount and speed according to the data received from the sensor.

In an embodiment of the invention, the powder coating system comprises waste gases released during the time the material is converted into powder form. The discharge of these waste gases is performed by an exhaust provided in the transmission line.

In an embodiment of the invention, the powder coating system comprises the control unit which controls, according to the data received from the sensor, conversion of the materials in different phases, structures and compositions on user's request, which are supplied into the system through the feeding unit, into powder form, wherein the control unit also controls separation of these materials into user-predetermined reservoirs according to the particle size predetermined by the user, and also controls the coating on the part so that each layer is in different composition by changing particle size of the material and/or powder.

In an embodiment of the invention, the powder coating system comprises the steps of:
Feeding the materials from the feeding unit to the plasma torch;
Converting the materials into powder form by means of the plasma torch;
Receiving composition data from the powders by means of a composition meter and transferring the obtained data to the control unit;
Comparing, in the control unit, the composition data transmitted from the composition meter with the ideal composition data predetermined by the user,
Transferring the powder, which is substantially at the ideal composition ratio determined by the user, to an appropriate reservoir according to the particle sizes, by means of a single vacuum unit which enables each of the reservoirs to be pressurized differently;
Collecting the powders with larger particle sizes than the powders in the first reservoir at the base of the first reservoir which allows the storage of powders whose form has changed by means of a plasma torch, wherein powders are collected by means of the vacuum unit creating vacuum by gravity, and transferring the powders with smaller particle sizes to the second reservoir via the transmission line;
Collecting the powders with larger particle sizes than the powders in the second reservoir at the base of the second reservoir by means of the vacuum unit creating vacuum by gravity, and transferring the powders with smaller particle sizes to the third reservoir via the transmission line;
Continuing the process of coating the part in any reservoir while continuing the processes of synthesizing the material to the powder size predetermined by the user and separating the material;
Discharging waste gases from the transmission line through the exhaust.

In an embodiment of the invention, the powder coating system comprises the feeding unit which converts the material prepared to be used as a radar absorbing material into a powder form.

In an embodiment of the invention, the powder coating system comprises a sub-section located at a bottom part of each reservoir for storing materials supplied in different phases and/or structures for powders which are not desired to be transmitted to other reservoirs and/or are dimensionally separated. Control of powders in different phases, particle sizes and/or structures is carried out by the control unit.

The powder coating system realized to achieve the object of the present invention is illustrated in the attached drawings, in which:

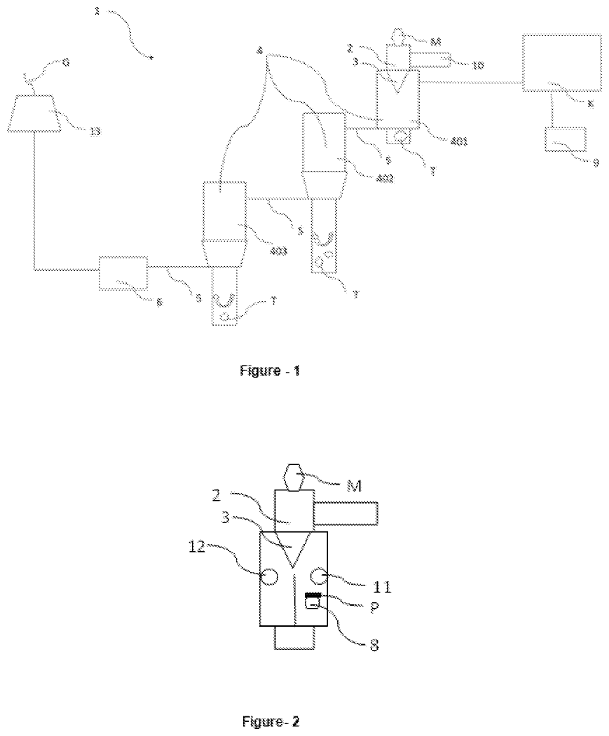

FIG. 1 is a schematic view of the powder coating system.

FIG. 2 is a schematic view of the first reservoir.

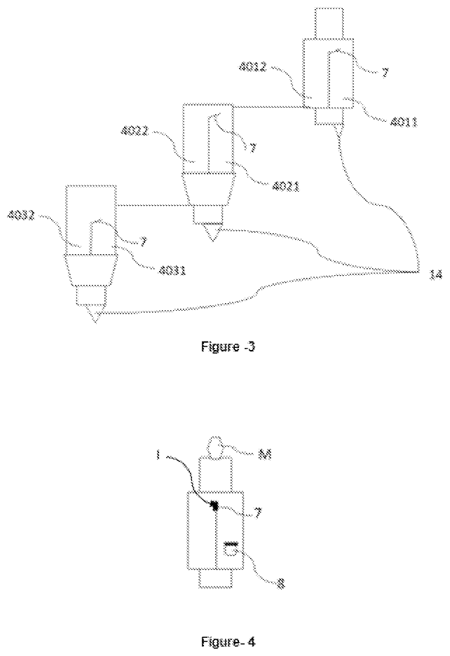

FIG. 3 is a schematic view of the reservoirs.

FIG. 4 is a schematic view of the valve in the first position (I).

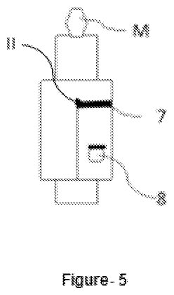

FIG. 5 is a schematic view of the valve in the second position (II).

All the parts illustrated in figures are individually assigned a reference numeral and the corresponding terms of these numbers are listed below:
1. Powder Coating System
2. Feeding Unit
3. Plasma torch
4. Reservoir
401. First Reservoir
4011. First Coating Chamber
4012. First Separation Chamber
402. Second Reservoir
4021. Second Coating Chamber
4022. Second Separation Chamber
403. Third Reservoir
4031. Third Coating Chamber
4032. Third Separation Chamber
5. Transmission Line
6. Vacuum Unit
7. Valve
8. Table
9. Motor
10. composition meter
11. Particle size meter
12. Sensor
13. Exhaust
14. Sub-section
(M) Material
(T) Powder
(P) Part
(K) Control Unit
(I) First Position
(II) Second Position

The powder coating system (1) comprises a material (M) in liquid, solid and/or gaseous form used in engineering applications; at least one feeding unit (2) which enables the materials (M) to be transmitted at a feed rate predetermined by the user; at least one plasma torch (3) located in connection with the feeding unit (2), which enables the form of the material (M) to be converted by the atomization method; a powder (T) in an amount predetermined by the user, which is formed by conversion of the material (M) by the plasma torch (3); a plurality of reservoirs (4) which allow the powder to be separated and collected in sizes predetermined by the user; at least one transmission line (5) which allows the powders (T) to be conveyed to the reservoir (4); a vacuum unit (6) which allows the powders (T) to be conveyed by vacuum on the transmission line (5); at least one part (P) which is pre-positioned by the user into the reservoir (4) for applying the coating process.

The powder coating system (1) according to the invention comprises a vacuum unit (6) which vacuums each chamber (4) simultaneously and allows the process of coating the part (P) in the reservoir (4) to be continued while the synthesis of the material (M) to the powder (T) size predetermined by the user and the separation processes in the reservoir (4) continue.

The system is provided with at least one feeding unit (2) which is suitable for use in engineering applications, especially for additive manufacturing, wherein the feeding unit (2) enables the materials in liquid, solid and/or gaseous form (M) to be converted into powder (T) form and enables the materials (M) to be conveyed at a feed rate predetermined by the user (2); at least one plasma torch (3) located in connection with the feeding unit (2), which enables the form of the material (M) to be converted by the atomization method. The powder (T) in an amount predetermined by the user is separated and collected in the reservoir (4). The transmission of the powders (T) to the reservoir (4) is provided by the transmission line (5). The vacuum unit (6) is used to transport the powders (T) by means of the transmission line (5). The part (P) suitable for coating in the reservoir (4) is placed in the reservoir (4) previously by the user.

While the processes of synthesizing the material (M) to the powder (T) size predetermined by the user and separating the material (M) in the reservoir (4) continue, it is enabled that the process of coating the part (P) in the reservoir (4) is continued simultaneously for a time predetermined by the user. While coating is carried out simultaneously in the reservoir (4), the separation processes of the powders (T) are provided by the vacuum unit (6), which continuously vacuums.

In an embodiment of the invention, the powder coating system (1) comprises a first reservoir (401) allowing the material (M), which has been converted into powder (T) form by means of the plasma torch (3), to be stored; a second reservoir (402), wherein the powders (T) with larger particle sizes than the powders (T) in the first reservoir (401) are collected at the base of the first reservoir (401) thanks to the vacuum unit (6) creating vacuum by gravity, and the powders (T) with smaller particle sizes than the powders (T) in the first reservoir (401) are transmitted to the second reservoir (402) by means of the transmission line (5); a third reservoir (403), wherein the powders (T) with larger particle sizes than the powders (T) in the second reservoir (402) are collected at the base of the second reservoir (402) thanks to the vacuum unit (6) creating vacuum by gravity, and the powders (T) with smaller particle sizes than the powders (T) in the second reservoir (402) are transmitted to the third reservoir (403) by means of the transmission line (5); a single vacuum unit (6) which provides different pressurization between each reservoir (4) along the transmission line (5) due to the vacuum effect. Thanks to the vacuum unit creating vacuum by gravity, it is enabled that the powders (T) with larger sizes than the first reservoir (401) are transferred to the second reservoir (402), and the powders (T) with larger sizes than the second reservoir (402) are transferred to the third reservoir (403). The powders (T) are transmitted to the reservoirs (3) by means of the transmission line (5).

In an embodiment of the invention, the powder coating system (1) comprises at least a first coating chamber (4011) located in the first reservoir (401) for coating the part (P); a first separation chamber (4012) located in the first reservoir (401) to continue powder (T) size separation simultaneously with the first coating chamber (4011); at least a second coating chamber (4021) located in the second reservoir (402) for coating the part (P) in the second reservoir (402) as a result of transferring the smaller sized powders (T) separated from the first reservoir (401) to the second reservoir (402) via the transmission line (5); a second separation chamber (4022) located in the second reservoir (402) to continue powder (T) size separation simultaneously with the second coating chamber (4021); at least a third coating chamber (4031) located in the third reservoir (403) for coating the part (P) in the third reservoir (403) after the powder (T) separated from the second reservoir (402) is transferred to the third reservoir (403) via the transmission line (5); a third separation chamber (4032) located in the third reservoir (403) to continue powder (T) size separation simultaneously with the third coating chamber (4031); at least one valve (7) located on each reservoir (4); the vacuum unit (6) which stops the coating processes and thus maintains the powder (T) supply continuity for the reservoirs (4) while the powder (T) separation and part (P) coating processes continue simultaneously in a first position (I) in which the valve (7) is opened, while the powder (T) separation process continues in a second position (II) in which the valve (7) is closed. The powder coating system (1) comprises the first coating chamber (4011) for coating the part (P) in the first reservoir (401); the first separation chamber (4012) which enables the material (M) converted into powder (T) form to be separated into the reservoirs (4). Continuing and/or stopping the coating process in the first coating chamber (4011) enables the simultaneous and permanent continuation of the powder (T) separation processes when desired by the user. Since the second separation chamber (4022) enables that the powders (T) in an amount predetermined by the user, which have been separated according to the powder (T) size and transmitted from the first reservoir (401) to the second reservoir (402), are transferred to the third reservoir (403), the powders (T) are provided to the third reservoir (403) in a continuous and permanent manner. In the powder coating system, thanks to the second coating chamber (4021) which enables coating on the part (P) simultaneously with the powders (T) in the second reservoir (402) in an amount determined by the user, powders (T) of separated sizes which are provided in the second reservoir (402) in an amount predetermined by the user can be coated on the part (P) while separation process for the powders (T) continue, such that the coating process is stopped when desired. The third separation chamber (4032) provides the transfer of the powders (T) in the third reservoir (403), wherein the powders (T) with a smaller particle size than the powders (T) in the second reservoir (402) are transferred to the third reservoir (403), so that the part (P) is enabled to be coated in the third coating chamber (4031) while the separation process is performed simultaneously in the third separation chamber (4032). Thanks to the valve (7) located in each reservoir (4), if the valve (7) is closed in the second position (II), the coating process can be stopped when a thickness desired by the user is reached and/or when the coating processes are desired to be stopped. If the valves (7) are in the first position (1) in which the valves are open, powder separation and part (P) coating processes can continue simultaneously.

In an embodiment of the invention, the powder coating system (1) comprises at least one table (8) located in the reservoir (4), which allows the formation of powder (T) of different particle sizes on the same part (P) predetermined by the user, and allows the part (P) to move in at least three axes; at least one motor (9) that provides the movement of the table (8). Thanks to the movable table (8), the powder (T) is coated on the part (P) in a particle size determined by the user. The table (8) is enabled to move by the motor (9).

In an embodiment of the invention, the powder coating system (1) comprises a part (P) which is coated in the first reservoir (401), such that the part (P) is coated simultaneously with the synthesis of the material (M) to a desired powder (T) size, by any of the methods of physical vapor deposition, chemical vapor deposition, hot/cold spraying, immersion or electronic deposition; a part (P) which is coated in the second reservoir (402) and the third reservoir (403) by the cold spraying method such that the part (P) is coated simultaneously with the synthesis of the material (M) to a desired powder (T) size. The part (P) is coated in the first reservoir (401) with the powder (T) by any of the methods of physical vapor deposition, chemical vapor deposition, hot/cold spraying, immersion or electronic deposition, such that the part (P) is coated simultaneously with the synthesis of the material (M) to a desired powder (T) size, wherein the powder is in a liquid form when the table (8) approaches the temperature of the plasma torch (3) or it is in solid form when the table (8) moves away from the temperature of the plasma torch (3).

In an embodiment of the invention, the powder coating system (1) comprises at least one composition meter (10) which measures organic material composition of the powders (T) in situ by characterizing the gases (G) obtained by the inert gas fusion (IGF) based combustion method; at least one control unit (K) which controls the process for changing the feed rate from the feeding unit (2) according to the measurement data obtained; at least one composition meter (10) transmitting the rate information from the feeding unit (2) to the control unit (K) for changing the feed rate. By means of the composition meter (10), the measurement of the organic material (M) composition is provided by characterizing the gases (G) obtained by using the inert gas fusion (IGF) based combustion method.

In an embodiment of the invention, the powder coating system (1) comprises the control unit (K) which uses a machine learning method by the ideal data reference predefined by the user to the control unit (K), and simultaneously changes the input data of the material (M) based on the data received from the gases (G) by means of the composition meter (10), wherein the control unit (K) allows the feed rate of different materials (M) from the feeding unit (2) to be changed, so that the powder (T) composition substantially corresponds to the composition ratio predetermined by the user. Based on the data obtained by the composition meter (10) from the gases (G), the control unit changes the input data of the material (M), allows the feed rates of different materials (M) from the feeding unit (2) to be changed, so that it allows the powder (T) composition to substantially correspond to the composition ratio predetermined by the user. In this way, a functional coating process can be performed by controlling the use of materials (M) with different elements and/or powders (T) with different sizes, layer by layer on the part (P).

In an embodiment of the invention, the powder coating system (1) comprises at least one particle size meter (11) located on the transmission line (5), which measures the particle size of the powder (T) using the laser diffraction method and transmits the measurement data to the control unit (K) in order to change the feed rates in the feeding unit (2). Thanks to the particle size meter (11), particle size of the powder (T) is continuously measured and the measurement data is processed by the control unit (K) to change the feed rates in the feeding unit (2).

In an embodiment of the invention, the powder coating system (1) comprises at least one sensor (12) located in each reservoir (4), which measures a coating thickness on the part (P); the control unit (K) which receives data from the sensor (12) to control transmission amount and rate of the material (M). Thanks to the sensor (12), the coating thickness of the part (P) which is coated in the reservoir (4) can be continuously measured and transmitted to the control unit (K). In this way, transmission amount and rate of the material (M) can be adjusted by the control unit (K).

In an embodiment of the invention, the powder coating system (1) comprises a waste gas (G) which is a waste product released during the conversion of the material (M) into powder (T) form; at least one exhaust (13) which allows the waste gases (G) to be discharged from the transmission line (5). On the system, the released waste gases (G) are discharged by the exhaust (13).

In an embodiment of the invention, the powder coating system (1) comprises the control unit (K) which enables particle size of the material (M) and/or the powder (T) to be changed, for materials (M) from the feeding unit (2) that can be in different phases and structures, in the reservoir (4) suitable for the desired particle size of the powder (T), thus controlling the coating process on the part (P) according to the data received from the sensor (12), so that each layer can be of a different composition. In this way, a functional coating process can be performed by controlling the use of materials (M) with different elements and/or powders (T) with different sizes, layer by layer on the part (P).

In an embodiment of the invention, the powder coating system (1) comprises the steps of:
Feeding the materials (M) from the feeding unit (2) to the plasma torch (3);
Converting the materials (M) into powder (T) form by means of the plasma torch (3);
Receiving composition data from the powders (T) by means of the composition meter (10) and transferring the obtained data to the control unit (K);
Comparing, in the control unit (K), the composition data transmitted from the composition meter (10) with the ideal composition data predetermined by the user,
Transferring the powder (T), which is substantially at the ideal composition ratio predetermined by the user, to an appropriate reservoir (4) according to the particle sizes, by means of a single vacuum unit (6) which enables each of the reservoirs (4) to be pressurized differently;
Collecting the powders (T) with larger particle sizes than the powders (T) in the first reservoir (401) at the base of the first reservoir (401) which allows the storage of powders (T) whose form has changed by means of the plasma torch (3), wherein powders (T) are collected by means of the vacuum unit (6) creating vacuum by gravity, and transferring the powders (T) with smaller particle sizes to the second reservoir (402) via the transmission line (5);
Collecting the powders (T) with larger particle sizes than the powders (T) in the second reservoir (402) at the base of the second reservoir (402) by means of the vacuum unit (6) creating vacuum by gravity, and transferring the powders (T) with smaller particle sizes to the third reservoir (403) via the transmission line (5);
Continuing the process of coating the part (P) in any reservoir (4) while continuing the process of synthesizing the material (M) to the powder (T) size predetermined by the user and the process of separating the material (M);
Discharging waste gases (G) from the transmission line (5) through the exhaust (13).

In an embodiment of the invention, the powder coating system (1) comprises a feeding unit (2) which allows the material (M) in powder (T) form to be produced for use as a radar absorbing material. Therefore, it is enabled that the material (M) suitable for use in a production method such as additive manufacturing is produced in powder (T) form.

In an embodiment of the invention, the powder coating system (1) comprises the control unit (K) which controls individual storage of materials (M) supplied in different phases and/or structures thanks to a plurality of sub-sections (14) located in each reservoir (4). By means of the sub-sections (14), the powders (T) that are not used in coating processes and that are separated according to their size in the chambers (4) are stored.

1. A powder coating system (1) comprising:
a material (M) in liquid, solid and/or gaseous form used in engineering applications;
at least one feeding unit (2) which enables the materials (M) to be transmitted at a feed rate predetermined by the user;
at least one plasma torch (3) located in connection with the feeding unit (2), which enables the form of the material (M) to be converted by the atomization method;
a powder (T) in an amount predetermined by the user, which is formed by conversion of the material (M) by the plasma torch (3);
a plurality of reservoirs (4) which allow the powder (T) to be separated and collected in sizes predetermined by the user;
at least one transmission line (5) which allows the powders (T) to be conveyed to the reservoir (4);
a vacuum unit (6) which allows the powders (T) to be conveyed by vacuum on the transmission line (5);
at least one part (P) which is pre-positioned by the user into the reservoir (4) for applying the coating process; and
a vacuum unit (6) which vacuums each chamber (4) simultaneously and allows the process of coating the part (P) in the reservoir (4) to be continued while the synthesis of the material (M) to the powder (T) size predetermined by the user and the separation processes in the reservoir (4) continue.

2. The powder coating system (1) according to claim 1, comprising:
a first reservoir (401) allowing the material (M), which has been converted into powder (T) form by means of the plasma torch (3), to be stored;
a second reservoir (402), wherein the powders (T) with larger particle sizes than the powders (T) in the first reservoir (401) are collected at the base of the first reservoir (401) thanks to the vacuum unit (6) creating vacuum by gravity, and the powders (T) with smaller particle sizes than the powders (T) in the first reservoir (401) are transmitted to the second reservoir (402) by means of the transmission line (5);
a third reservoir (403), wherein the powders (T) with larger particle sizes than the powders (T) in the second reservoir (402) are collected at the base of the second reservoir (402) thanks to the vacuum unit (6) creating vacuum by gravity, and the powders (T) with smaller particle sizes than the powders (T) in the second reservoir (402) are transmitted to the third reservoir (403) by means of the transmission line (5); and
a single vacuum unit (6) which provides different pressurization between each reservoir (4) along the transmission line (5) due to the vacuum effect.

3. The powder coating system (1) according to claim 1, comprising:
at least a first coating chamber (4011) located in the first reservoir (401) for coating the part (P);
a first separation chamber (4012) located in the first reservoir (401) to continue powder (T) size separation simultaneously with the first coating chamber (4011);
at least a second coating chamber (4021) located in the second reservoir (402) for coating the part (P) in the second reservoir (402) as a result of transferring the smaller sized powders (T) separated from the first reservoir (401) to the second reservoir (402) via the transmission line (5);
a second separation chamber (4022) located in the second reservoir (402) to continue powder (T) size separation simultaneously with the second coating chamber (4021);
at least a third coating chamber (4031) located in the third reservoir (403) for coating the part (P) in the third reservoir (403) after the powder (T) separated from the second reservoir (402) is transferred to the third reservoir (403) via the transmission line (5);
a third separation chamber (4032) located in the third reservoir (403) to continue powder (T) size separation simultaneously with the third coating chamber (4031);
at least one valve (7) located on each reservoir (4); and
the vacuum unit (6) which stops the coating processes and thus maintains the powder (T) supply continuity for the reservoirs (4) while the powder (T) separation and part (P) coating processes continue simultaneously in a first position (I) in which the valve (7) is opened, while the powder (T) separation process continues in a second position (II) in which the valve (7) is closed.

4. The powder coating system (1) according to claim 1, comprising:
at least one table (8) located in the reservoir (4), which allows the formation of powder (T) of different particle sizes on the same part (P) predetermined by the user, and allows the part (P) to move in at least three axes; and
at least one motor (9) that provides the movement of the table (8).

5. The powder coating system (1) according to claim 2, comprising a part (P) which is coated in the first reservoir (401), such that the part (P) is coated simultaneously with the synthesis of the material (M) to a desired powder (T) size, by any of the methods of physical vapor deposition, chemical vapor deposition, hot/cold spraying, immersion or electronic deposition;
a part (P) which is coated in the second reservoir (402) and the third reservoir (403) by the cold spraying method such that the part (P) is coated simultaneously with the synthesis of the material (M) to a desired powder (T) size.

6. The powder coating system (1) according to claim 1, comprising:
at least one composition meter (10) which measures organic material composition of the powders (T) by characterizing the gases (G) obtained by the inert gas fusion (IGF) based combustion method;
at least one control unit (K) which controls the process for changing the feed rate from the feeding unit (2) according to the measurement data obtained; and
at least one composition meter (10) transmitting the rate information from the feeding unit (2) to the control unit (K) for changing the feed rate.

7. The powder coating system (1) according to claim 6, wherein the control unit (K) uses a machine learning method by the ideal data reference predefined by the user to the control unit (K), and simultaneously changes the input data of the material (M) based on the data received from the gases (G) by means of the composition meter (10), wherein the control unit (K) allows the feed rate of different materials (M) from the feeding unit (2) to be changed, so that the powder (T) composition substantially corresponds to the composition ratio predetermined by the user.

8. The powder coating system (1) according to claim 6, comprising at least one particle size meter (11) located on the transmission line (5), which measures the particle size of the powder (T) using the laser diffraction method and transmits the measurement data to the control unit (K) in order to change the feed rates in the feeding unit (2).

9. The powder coating system (1) according to by claim 6, comprising at least one sensor (12) located in each reservoir (4) which measures a coating thickness on the part (P); and wherein the control unit (K) receives data from the sensor (12) to control transmission amount and rate of the material (M).

10. The powder coating system (1) according to claim 1, comprising:
a waste gas (G) which is a waste product released during the conversion of the material (M) into powder (T) form; and
at least one exhaust (13) which allows the waste gases (G) to be discharged from the transmission line (5).

11. The powder coating system (1) according to claim 9, wherein the control unit (K) enables particle size of the material (M) and/or the powder (T) to be changed, for materials (M) from the feeding unit (2) that can be in different phases and structures, in the reservoir (4) suitable for the desired particle size of the powder (T), thus controlling the coating process on the part (P) according to the data received from the sensor (12), so that each layer can be of a different composition.

12. A method of operating a powder coating system (1) according to claim 10, comprising the steps of:
feeding the materials (M) from the feeding unit (2) to the plasma torch (3);
converting the materials (M) into powder (T) form by means of the plasma torch (3);
receiving composition data from the powders (T) by means of the composition meter (10) and transferring the obtained data to the control unit (K);
comparing, in the control unit (K), the composition data transmitted from the composition meter (10) with the ideal composition data predetermined by the user,
transferring the powder (T), which is substantially at the ideal composition ratio predetermined by the user, to an appropriate reservoir (4) according to the particle sizes, by means of a single vacuum unit (6) which enables each of the reservoirs (4) to be pressurized differently;
collecting the powders (T) with larger particle sizes than the powders (T) in the first reservoir (401) at the base of the first reservoir (401) which allows the storage of powders (T) whose form has changed by means of the plasma torch (3), wherein powders (T) are collected by means of the vacuum unit (6) creating vacuum by gravity, and transferring the powders (T) with smaller particle sizes to the second reservoir (402) via the transmission line (5);
collecting the powders (T) with larger particle sizes than the powders (T) in the second reservoir (402) at the base of the second reservoir (402) by means of the vacuum unit (6) creating vacuum by gravity, and transferring the powders (T) with smaller particle sizes to the third reservoir (403) via the transmission line (5);
continuing the process of coating the part (P) in any reservoir (4) while continuing the process of synthesizing the material (M) to the powder (T) size predetermined by the user and the process of separating the material (M); and
discharging waste gases (G) from the transmission line (5) through the exhaust (13).

13. The powder coating system (1) according to claim 1, comprising a feeding unit (2) which allows the material (M) in powder (T) form to be produced for use as a radar absorbing material.

14. The powder coating system (1) according to claim 6, wherein the control unit (K) controls individual storage of materials (M) supplied in different phases and/or structures thanks to a plurality of sub-sections (14) located in each reservoir (4).
